(19) United States
(12) Patent Application Publication
(10) Pub. No.: US 2006/0060264 A1
(43) Pub. Date: Mar. 23, 2006

(54) Wood shaving machine

(76) Inventors: Gregory E. Glover, Eldorado, AR (US); George W. Glover, Lillie, LA (US)

Correspondence Address: BLACKWELL SANDERS PEPER MARTIN LLP, 720 OLIVE STREET, SUITE 2400, ST. LOUIS, MO, 63101, US

(21) Appl. No.: 10/945,190

(22) Filed: Sep. 20, 2004

(51) Int. Cl. B27L 5/04; B27M 1/00

(52) U.S. Cl. 144/363

(57) ABSTRACT

A wood shaving apparatus and method are provided. The apparatus comprises a plurality of cutting heads and drive means to move wood pieces by the cutter heads in a single direction and along a restricted path of movement. Wood shavings are removed from the wood pieces by each of the cutter heads and the wood shavings are collected for further use.

### BACKGROUND OF INVENTION

The present invention is directed to an apparatus for cutting shavings from pieces of wood preferably dimension lumber. The shavings are used for a bedding material for animals such as horses, cows and household pets such as dogs and cats if desired. It is particularly suitable for larger animals and for use in stalls.

There are various apparatuses patented for making shavings from wood pieces. These machines take two basic forms. One type of machine removes cuttings from the ends of the pieces of wood and another type of machine removes shavings from an elongate side of wood, typically logs place in a hopper. Some of these machines may be characterized as a disc cutter and some are drum cutters. In a disc cutter, the cutters move in a plane generally perpendicular to the axis of rotation. Examples of such machines are shown in U.S. Pat. Nos. 5,762,122, 5,211,688 and 5,261,469. The other type of a cutter device is a drum cutter and has one or more cutting blades that extend in a direction generally parallel to the axis of rotation of the cutter head drum. Examples of such machines are disclosed in U.S. Pat. Nos. 3,679,143, 3,736,967, 3,991,946 and 5,143,311.

Those machines that remove shavings from an elongate face of the wood being cut, an examples of which are disclosed in U.S. Pat. Nos. 1,795,064, 2,840,127 and 3,286,745 process logs. In the '745 patent, the logs are placed in a hopper and under their own weight are urged into engagement with a plurality of cutting heads. Pairs of cutting heads are provided and each cutter head in a pair rotate in opposite directions. The hopper moves in a reciprocal manner over the cutter heads. The weight of the logs applies a downward force to urge the lower positioned logs into engagement with the cutter heads, thus requiring a significant number of logs within a hopper to effect firm engagement between the cutter heads and their cutting blades and the wood being cut. The downward force is not uniform from log to log or hopper full to hopper full. When effecting cutting, the cutter heads will apply an upward force to counteract the downward force of the logs. Such an apparatus would also not be adaptable for shaving dimension lumbers which has a generally rectangular cross sectional shape since in being dumped in a hopper the exposed face for cutting may not be uniform nor parallel to the plane of the cutter heads resulting in non-uniform cuttings being removed.

The machines described above as the disc cutters remove cuttings from the end of a piece of wood and can handle dimension lumber. Dimension lumber is that lumber which has a generally rectangular cross sectional shape and may be commonly found in lumber yards, examples of which are 2×4's and 2×6's, etc. Such lumber is commonly used in construction of homes, buildings and the like.

In the manufacturing of floor joists and trusses and roof trusses, scrap dimension lumber is produced and has little if any value. One potential use for such lumber is in the manufacture of particle board, chip board and litter shavings. However, to date, no machine which is known to the inventors, has been effective in shaving scrap dimension lumber to produce litter shavings. Such litter shavings are preferably thin and have a fairly sizeable surface area as compared to particles used in particle board which is essentially sawdust. Preferably, shavings for litter would have a curl to provide a low bulk density and a resilience when walked or lain upon. Such shavings are also preferably relatively thin, i.e., on the order of 0.030″ thick or less. Such shavings preferably have at least one major dimension either length or width, of at least 0.5″ and the transverse dimension of at least about 0.25″. Thickness of a shaving is preferably less than about 0.030″. Such shavings are also preferably curled. Such shavings may be easily produced using a sharp hand plane but a brand plane is not adapted for commercial use to produce large quantities of shavings.

Wood planers and jointers are well known in the art. Wood planers are used to reduce the thickness of a piece of wood, to make two opposing faces generally parallel and to smooth the surfaces. Such planers have a drum cutter head and drive rollers positioned on opposite sides of the cutter head which engage the surface being planed. Typically, the cutter head is positioned on the top side of the planer and the wood moves over an underlying bed. The drive rollers move the wood through the planer and into and out of engagement with the cutter head blades. The cutter head removes wood usually in chip form from an elongate face of the board, i.e., not an end cut. Jointers are also known, and they utilize a two segment bed, one segment of the bed being fixed in position and the other segment of the bed being moveable relative thereto to control the depth of the cut. A drum type cutter head is mounted between the two bed segments and utilizes a plurality of cuttings knives thereon. Jointers are used to produce a straight edge or face usually on a piece of dimension lumber. Jointers typically produce particles and not curls. Both jointers and planers utilize only one cutter head and are not adapted to produce shavings by removing wood from a board or the like and reducing the wood to a size as small as possible.

There is thus a need for an improved wood shaving machine which will remove as much wood shavings from a wood board as can be readily done to produce wood shavings.

### SUMMARY OF THE INVENTION

The present invention involves the provision of a machine for forming shavings from wood pieces. The wood pieces are preferably dimension lumber. The machine has the plurality of sequentially positioned cutter heads each engaging a piece of wood in turn with the wood moving generally in one direction from a feed end to a discharge end. Drive rollers are provided and are spaced on centers from one another a spacing less than the length of the wood pieces being shaved. A flow path is defined between the cutter heads and the drive rollers restraining the wood in two opposite directions permitting wood to move substantially in only one direction. In a preferred embodiment, a drive roller has its center of rotation or its point of contact with the wood pieces generally opposite to the point of contact by the cutter head with the wood piece passing therebetween. Shavings are formed and preferably are curled with the shavings being useable as bedding for animals.

The present invention involves the provision of a method of forming wood shavings. A plurality of cutter heads sequentially engage a piece of wood to have shavings removed therefrom with the cutter heads removing shavings from an elongate face of the wood pieces. The wood pieces move generally only in one direction between a feed end and a discharge end. The wood pieces sequentially engage the cutter heads and make only one pass by each cutter head.

### BRIEF DESCRIPTION OF DRAWINGS

FIG. 1 is a perspective view of the wood shaving machine of the present invention with portions broken away to show internal details of the machine.

FIG. 2 is an end elevation view as viewed from a feed end of the wood shaving machine, with portions broken away to show structural detail.

FIG. 3 is a side elevation view of the wood shaving machine of FIG. 1 as seen from the drive side.

FIG. 4 is a top plan view of the apparatus of FIG. 1.

FIG. 5 is a side elevation view of the apparatus of FIG. 1 but shown from the opposite side as seen in FIG. 3.

FIG. 6 is a schematic illustration of the internal components of the apparatus of FIG. 1 showing the drive rollers, cutter heads and drive components therefore.

FIG. 7 is a schematic illustration of a cutter head, respective drives and wood piece.

FIG. 8 is a side elevation view showing the wood shaving machine with an alternate shaving collection system.

The numbers throughout the various figures designate like or similar parts.

### DETAILED DESCRIPTION OF THE INVENTION

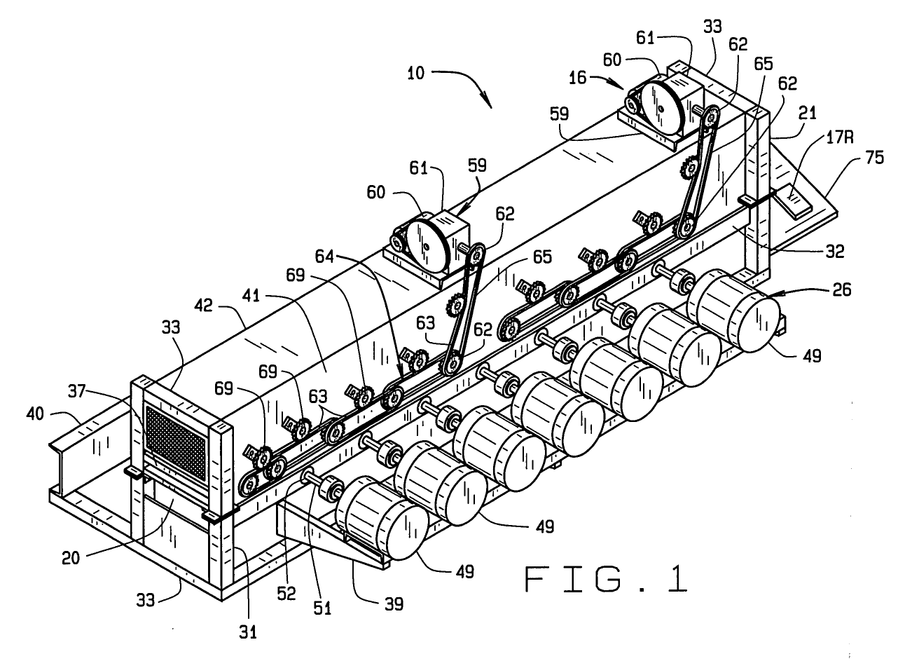

The reference numeral 10 designates generally the wood shaving apparatus of the present invention. The machine includes a plurality of cutter heads 12 mounted to a frame 14 for rotation. A drive device or system, designated generally 16, is mounted to the frame 14 and is operable to move wood pieces 17 along a path of traverse 18 past the cutter heads 12 in sequential order whereby upon passing by a cutter head 12 wood shavings 25 are removed and each cutter head 12 in turn makes the wood pieces thinner. The machine 10 has a feed end 20 and a discharge end 21 and traverse path 18 extends between the feed end 20 and discharge end 21. A bed 23 is provided to support the wood pieces 17 as they move a long the traverse path 18 and by the cutter heads 12. While the machine 10, as seen in FIG. 1 has the components thereof arranged for removing wood from a downwardly facing elongate surface or face 24A of the wood pieces 17, it is to be understood that the components may be arranged for removing wood shavings 25 from a side face 22 or an upwardly facing elongate surface 24B of the wood pieces. By removing wood shavings 25 from the wood pieces 17 on a downwardly facing surface 24A, the removed shavings can be easily discharged downwardly into an upwardly opening bin simplifying the construction of the machine 10. The traverse path 18 is defined by components of the drive 16, bed 23 and cutter heads 12 and confines the wood pieces 17 in two opposite directions, i.e., as seen in FIG. 1 top and bottom, to restrain the wood pieces 17 from moving except in a direction along the traverse path 18. A drive device or system 26 is provided for powering the cutter heads 12. The frame 14 includes a first support structure 28 for rotatably carrying the cutter heads 12 and a second support structure 29 for carrying the drive 16. In the illustrated structure, the support structure 28 is positioned below the support structure 29.

The frame 14 includes a plurality of legs 31 and structural supports 32 secured to and extending between the legs 31 along the length of the machine 10. I beams and square tubing are suitable materials for the legs 31 and supports 32. Cross supports 33 may also be provided to connect the opposite sides of the machine 10 together and provide support for various of the machine elements. The bed 23 extends between the feed end 20 and the discharge end 21 and has an upwardly facing surface segments 36, denoted A-H for clarity, adapted to receive and support wood pieces 17 thereon. As shown, the bed 23 is segmented as described below. A gate member 37 may be provided adjacent the feed end with a spacing from the bed 23 to prevent excessively thick wood pieces 17 from being fed into the cutting area of the machine 10. Wings 39, 40 may be provided on opposite sides 41, 42 respectively, for support of additional machine elements as described below. The wings 39, 40 may be composed of various structural elements and may be welded to the sides 41, 42 or otherwise suitably attached.

There are plurality of cutter heads 12 positions along the traverse path 18 each having a portion thereof exposed through the bed 23 as for example in openings 44 with the openings 44 separating the bed into segments 23A, B, C, D, E, F, G and H. The cutter heads 12 are preferably of the drum type each having a plurality of circumferentially spaced cutter knives 46 extending outwardly therefrom, for example 0.030″ to 0.060″, for engagement with and operable for removing shavings from an elongate surface or face 24, or alternately 22, of the wood pieces 17 passing thereby. Such a cutter head 12 is a 6″ diameter 13″ long four knife cutter head from Southern Carbide, Inc. of Shreveport, La. The cutter knives 46 may be of any suitable material and are removable for either replacement or sharpening. Because surface finish is not an issue, relatively low grade tool steel may be used for the knives 46. The number of knives required for each cutter head 12 will be determined by both the rotational speed or angular velocity of the cutter head 12 and its circumference as well as the fineness of shavings and the speed of traverse of the wood pieces 17 along the path 18. A cutter head 12 having a diameter on the order of 6-12 inches is useable and a number of knives per cutter head of 3 or 4 is also acceptable. The axis of rotation of the cutter heads 12 is generally parallel to the upwardly facing surface 36 and generally perpendicular to the longitudinal axis of the bed 23. Any number of cutter heads 12 may be provided and will be determined by the thickness of cut that the cutter head can make, the thickness of the wood pieces 17, type of wood and the various operating parameters i.e., speeds or angular velocities of the drives and cutter heads as described herein. The details of the parts of the machine 10 and its operation are based on the wood being soft wood, e.g., pine, spruce, etc. However, the machine may be easily set up for other woods, e.g., hard woods like oak, maple, etc. It has been found that seven cutter heads are effective in shaving what are commonly referred to as two-by-fours or other “two-by” dimension lumber having an actual thickness of 1½ inches which are commonly referred to as two inch thick lumber pieces.

The cutter drive system 26 can be any suitable drive to effect rotation of the cutter heads 12. In the illustrated structure, each cutter head 12 is operably connected to a respective electric motor 49. A 10 horsepower motor operating at about 3500 rpm's is acceptable, the cutter heads rotating at the same angular velocity. The motors 49 are connected in driving relationship to a respective cutter head 12 preferably by a direct drive. The motor shaft is directly linked to the shaft 51, as with a chain type coupling 53, on which a cutter head 12 is mounted. The shafts 51 are suitably mounted in bearings 52 which as shown are flanged pillow block bearings. Because there is frequent need for maintenance of the cutter heads 12, and particularly their knives 46, the cutter heads should be easily accessible for knife removal and replacement for sharpening or replacement. In the illustrated structure, the shafts 51 extend outwardly of the back side 42 of the machine 10 and have an exposed length sufficient for allowing a cutter head to be slid from a position along the path 18 to a position outside of the machine portions defining the path for easy access to the knives 46. The cutter heads 12 each has a drum 54 releaseably secured in position on the shaft 51 to permit its fixing in a position along the path 18 which fixing may be released for sliding along the exposed length of shaft 51 for servicing of the knives or the drum 54. The drums 54 may be keyed each to its respective shaft 51 to prevent relative rotation and locked longitudinally in place on the shaft 51 with collars. The above-referenced cutter head 12 is provided with a hydraulic arrangement, as are known in the art, to releasably lock the cutter head to the shaft 51 with hydraulic pressure. After servicing, the drum may be slid back into the traverse path 18 and fixed in place. The free ends of the shafts 51 are also rotatably carried by bearings 52 mounted to the wing 40. The motors 49 may be of any suitable type and may have a fixed speed or a variable speed as desired.

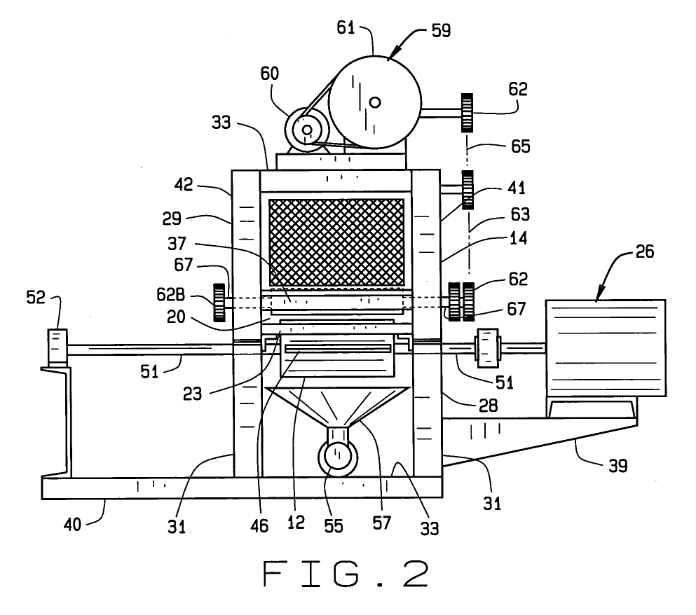

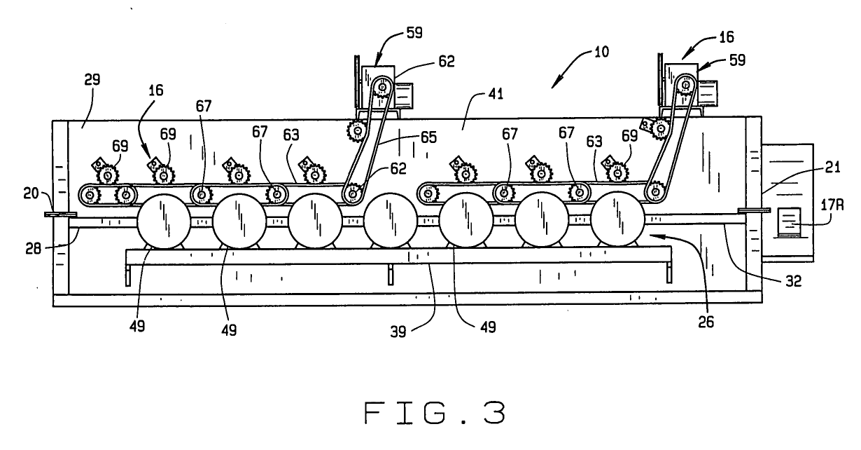

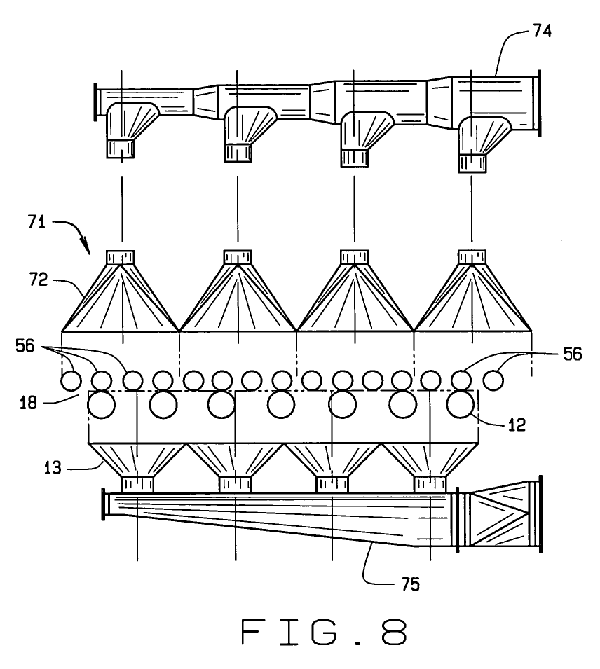

The frame 14 under the bed 23 provides for an area into which shavings from the wood pieces 17 may be discharged for subsequent collection. A conveyor system such as a belt conveyor, screw auger 55 in a hopper 51 bottom, FIG. 2, or a pneumatic system 71, FIG. 8, may be provided under the cutter heads 12 to convey the shavings 25 to a location exterior of the machine 10 to facilitate collection and removal for subsequent packaging and/or processing. The pneumatic system 71 can include upper and lower collection chambers 72, 73 respectively connected to ducts 74, 75 respectively which in turn are connected to a source of reduced air pressure, e.g., the suction side of a blower.

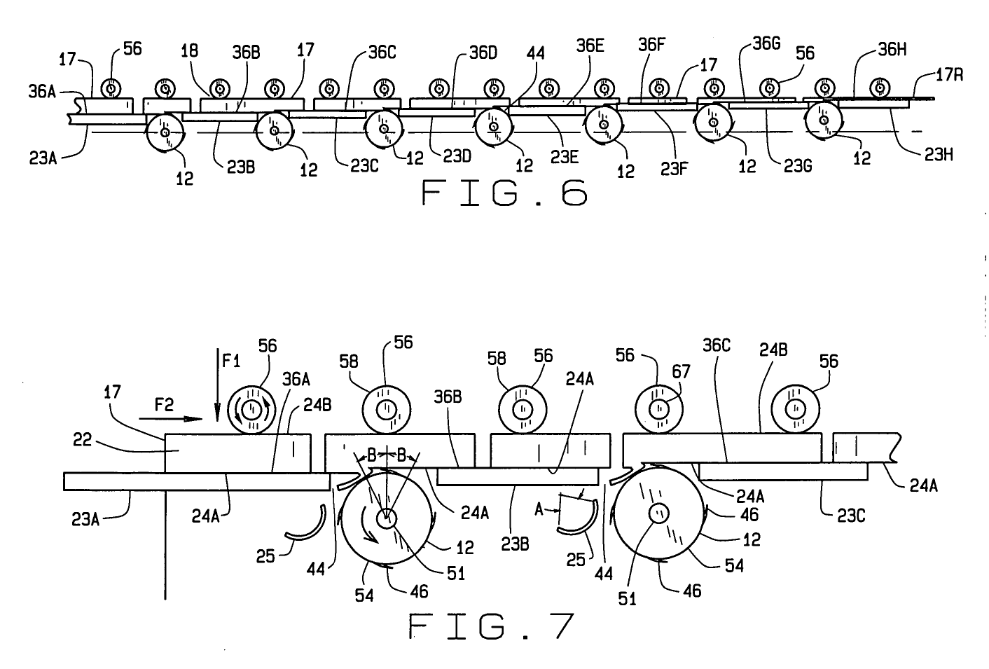

The drive system 16 is provided for effecting movement of the wood pieces along the path 18 from the feed end 20 to the discharge end 21. In the illustrated structure, a plurality of friction rollers 56 are positioned along a substantial portion of the length of the traverse path 18 and are positioned above and in spaced relationship from the respective surface segment 36A-F. The rollers 56 along with the surfaces, 36A-F define a restrained or confined path 18 for movement of wood pieces there along, i.e., the wood pieces are restricted in movement in two opposite directions, and in the case of the machine 10 shown in the figures, in a downward direction and in an upward direction. The drive 16 is operable to take pieces of wood 17 fed at the feed end 20, sequentially move them by the cutter heads 12 and discharge them out of the discharge end 21. It is preferred that the drive system 16 be operable to apply a multi-directional force to the wood pieces with the forces preferably being orthogonal to one another as described in detail below. One force, F1, FIG. 7, will induce the wood pieces 17 to remain engaged with the knives of the cutter heads 12 and the other force, F2, to move the wood piece past the cutter heads in sequential order and along the path 18 in a direction generally parallel to the longitudinal axis of the bed 23. The force F1 may be provided by any of the three rollers individually or in combination adjacent a respective cutter head 12. Those rollers include the one immediately above and the one roller 56 upstream of the respective cutter head 12 and the one immediately downstream of the respective cutter head. Preferably, the force F1 is applied by the immediately adjacent roller 56 positioned generally directly above the respective cutter head as best seen in FIG. 7 where F1 is directed generally between and through the axes of rotation of cutter head 12 and respective immediately adjacent roller 56 when the angle B, described below is about 0 degrees. As seen in FIG. 7, the bed 23 is generally horizontal and the centers of rotation of the cutter head 12 and its immediately adjacent and closest cutter head 12 roller 56 is in a generally vertical orientation as best seen with the left hand cutter head 12 in FIG. 7. The center of rotation of the above positioned roller 56 can vary from centered to an angle B of plus or minus about 20 degrees from a vertical line going through the center of rotation of the cutter head 12. The force F2 is supplied in turn by each of the rollers 56, first by the downstream roller 56 then by the above roller 56 and then by the downstream roller 56. The upstream roller 56 pushes the wood piece 17 into the cutter head and the above roller 56 and downstream roller 56 pull the wood pieces past the cutter head 12. As shown, the drive 16 includes a plurality of friction rollers 56 each rotatably mounted to the frame 14 and extending generally transversely across the path 18 and generally perpendicular to the longitudinally axis of the bed 23. The rollers 56 preferably have a friction drum 58 adapted to engage a surface of the wood pieces 17 opposite to the surface that engages the cutter heads 12. Suitable rollers 56 are available from IBT of Eldorado, Ark. and manufactured by PCI. The contacting material of the drum 58 has sufficient friction with the wood pieces 17 to move them along the path 18 against friction with the bed 23 and the force applied to the wood pieces 17 by the knives 46 of the cutter heads 12. A preferred wood piece 17 contacting material is elastomeric, e.g., rubber. The rotational direction of the rollers 56 is such as to move the wood pieces 17 from the feed end to the discharge end and preferably the direction of rotation of the cutter heads 12 is in the same rotational direction as the rollers 56 (clockwise as seen in FIG. 7) but because it engages an opposite surface 24A of the wood piece 17 the knives 46 move against the direction of the movement of the wood pieces 17 along the path 18 during cutting. FIG. 7 shows the direction of the applied forces F1, F2 by the rollers 56 and the direction of rotations of the rollers 56 and cutter heads 12. FIG. 7 also shows the degree of curl of the shavings 25. Preferably, the curl is at least a segment of an arc A of at least about 30°.

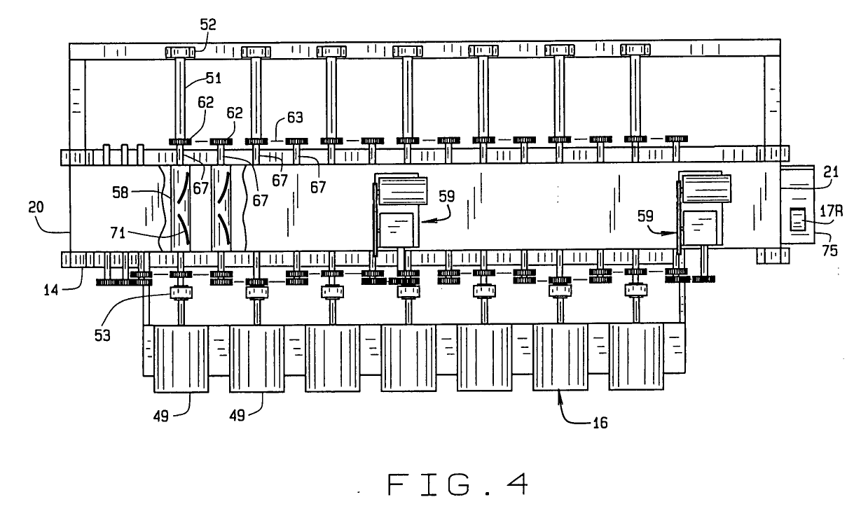

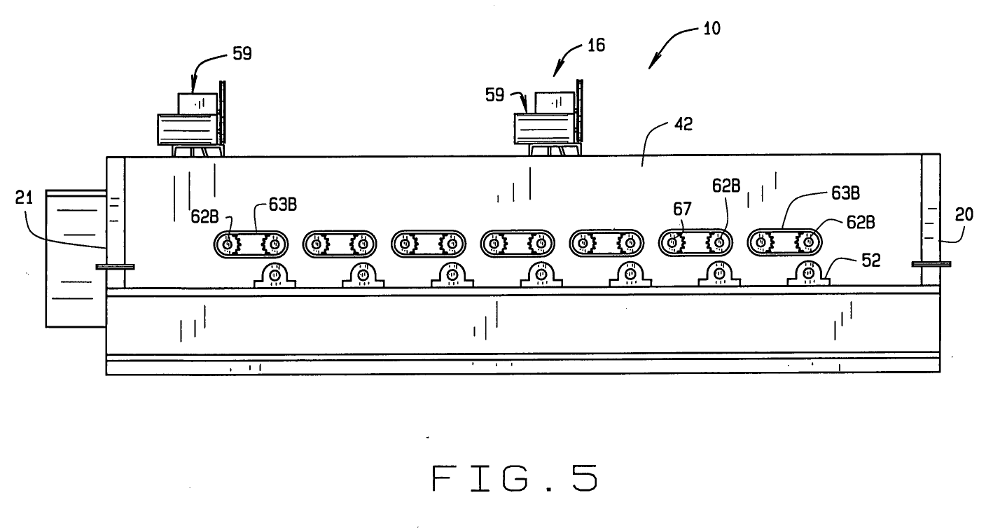

The rollers 56 are suitably driven by the drive system 16. As shown, two separate drive devices 59 such as an electric motor 60 combined with a gear reducer 61, are provided. A suitable motor is a Siemen ETG5995 and a suitable gear reducer is a Hub City 0220-62703-321. The drive devices 59 are connected in driving relationship to a series of drive elements such as sprockets and chains 62, 63 respectively. The drive devices 59 are each connected to a respective driven sprocket and chain arrangement 64 via a driver chain and sprocket arrangement 65 comprising the sprockets 62 and chains 63. It is to be understood that even though two drive devices 59 are shown, one may suffice or more than two may be used. The sprockets 62 are secured to shafts 67 which are in turn connected to the rollers 56. Each cutter head 12 is associated with a plurality of rollers 56. Preferably, three rollers 56 are associated with each cutter head 12 with one of the three cutter heads being shared with an adjacent cutter head 12. This is best seen in FIG. 7. One roller 56 is positioned on the downstream side of a respective cutter head 12 and one roller 56 is positioned on the upstream side of a respective cutter head 12. A third roller 56 is positioned above a cutter head 12. These rollers are driven on the back 41 via a chain 63B and sprocket 62B and driven from an upstream roller 56 shaft 67. The spacings between the points of contact with the wood, as more fully described below, are such as to ensure engagement between a piece of wood at all times. For example, the spacing between the axis of rotation of the rollers 56 can be 7 inches allowing the through put of wood having a length of approximately 10 inches or more. By positioning a roller 56 above the cutter head 12 as described above, deformation of the wood during cutting and the possible chattering during the cutting operation is reduced. The rollers 56 above the cutter heads 12 are driven, as best seen in FIG. 4, from the back side 42 of the machine by connecting an upstream roller via a chain and sprock connection with the centered roller 56. Other suitable drive arrangements can be provided. By an apportion of the drive on the back side, simplification of the drive on the front side can be accomplished. By rotation of the shafts 67, rotation of the rollers 56 may be effected. To maintain tension and reduce slack in the chains 63, idler sprockets 69 may be provided and may be mounted in a moveable manner to effect adjustment of the slack in the chain 63 and hence the amount of slack in the chain 63. The drums 58 may be provided with chevron style grooves 71 (FIG. 4) if desired. The widths of the rollers 56, path 18 and cutter heads 12 are adequate, in a preferred embodiment, to accommodate the feeding of a plurality of wood pieces 17 in side by side relationship to pass through the machine 10 simultaneously. A path width of 13 inches has been found acceptable.

As the wood pieces 17 are thinned successfully by each cutter head 12, an accommodation needs to be made for the thinner pieces. This can be accomplished by reducing the spacing between each of the rollers 56 and the respective surface 36A-F of the bed 23. The bed 23 can be made in segments with each segment being moveably upwardly or downwardly if it is desired to be able to adjust the spacing. Likewise, the rollers may also be mounted to be able to be moved either closer to or farther away from a respective surface 36A-F. Additionally, the drum 58 may have sufficient resilience within the friction material to accommodate different thicknesses of wood pieces 17. In a preferred embodiment, the bed 23 and its spacing from the outer surface of the rollers 56 along the path 18 are fixed but different and decreasing from the feed end to the discharge end 20, 21 respectively. Stepped changes in spacing of ⅛″ to ¼″ and preferably about 3/16″ are usable. Likewise, it may be desirable to be able to adjust the cutting depth of each of the cutter heads 12 which can be accomplished by having each of the cutter heads mounted in a manner to be moved up or down or have the segments of the bed 23 moveable up or down relative to the cutting portions of each of the cutter heads 12. If the starting wood pieces are consistent in thickness, then the bed segments and the cutter heads need not be moveable relative from one another but may be fixed with each cutter head taking off a predetermined thickness of wood e.g., ⅛″ to ¼″ and preferably about 3/16″, as the wood pieces pass thereby.

The spacing between the rollers 56 along the length of the path 18, and in particular their points of contact with the wood pieces 17 as they pass thereunder, in the illustrated apparatus 10 is fixed. The spacing S needs to be longer than the length L of the wood pieces 17 passing thereunder so that at least one driving roller 56 is always in engagement with a wood pieces 17 until it is ready for discharge from the discharge end. The spacing S is preferably at least 2 to 3 inches less than the length L of the wood pieces 17 being processed by the apparatus 10. Wood pieces are short as 10″ may be processed.

At the discharge end 21, the wood pieces 17 have been thinned but there is still a remainder 17R of the wood piece 17. This thinned remainder 17R is then passed to a chute 75 for collection and further use if desired.

The present invention is better understood by a description of its method of operation. Wood pieces 17 are fed to the feed end 20 of the machine 10 and urged into engagement with the first roller 56. The roller 56 engages the wood piece 17 on one elongate surface and moves the wood piece into engagement with the knives 46 of the first cutter head 12 which moves its cutting knives into engagement with the downwardly facing surface 24A which is generally opposite to the surface 36 engaged by the roller 56. The orthogonal forces F1, F2 are applied to the wood 17, one holding the wood piece in engagement with the cutter head 12 and one force moving the wood piece through the machine advancing it to a second roller 56, positioned on the opposite side or downstream side of the cutter head 12 which will engage the wood piece 17 and move it into engagement with a second cutter head 12 applying the same orthogonal forces and so on down the line until the wood piece exits the discharge end. The wood shavings 25 removed from the wood pieces 17 are discharged through the opening into which the cutter heads 12 are mounted and discharged to an area below the bed 23. They may be collected there for manual removal or fed to a feed mechanism 77 such as a conveyor belt for conveying to a location for subsequent handling, for example, packaging. The shavings 75 may also be taken away from the apparatus 10 by a vacuum removal system or air conveying device as are known in the art. In operation, the wood pieces 17 move from the feed end 20 the discharge end 21 generally in a linear path and move only in one direction, i.e., from the feed end to the discharge end. The rollers 56 apply the orthogonal forces F1, F2, i.e., one to hold the wood piece in engagement with the cutter head 12 and one to move the wood piece along the path 18. Shavings 25 are removed from an elongate face 24A of the wood pieces 17. Wood pieces 17 may be fed to the machine in essentially a single file or one piece at a time or may be fed simultaneously in side by side relationship. The wood pieces 17 pass sequentially by each of the cutter heads and engage one cutter head only in one pass. Preferably, the wood piece 17 are scrap dimension lumber, for example, 2×4's, 2×6's, 2×8's, etc.

The remainder 17R of the wood pieces 17 after shaving and discharge from the apparatus 10, may be collected for further use if desired.

While certain embodiments of the apparatus and method are disclosed therein, the present invention is not to be limited to the specific disclosed steps or construction except to the extent that such are found in the appended claims.

What is claimed:

1. A wood shaving machine comprising:
a bed having a generally upwardly facing support surface, a feed end and a discharge end;
a plurality of cutter heads positioned along a traverse path between the feed end and discharge end;
a first drive device operably associated with the cutter heads to effect relative movement between wood moving along the path and the cutter heads to effect cutting of shavings from the wood; and
a second drive device operable to effect movement of wood to be shared along the path in a direction from the feed end to the discharge end, said wood movement being principally in one direction, said second drive device being operable to move wood to be shaved sequentially to and by the cutter heads.

2. The wood shaving machine as set forth in claim 1 wherein the cutter heads including drum heads with cutter knives extending across at least a portion of the path and having a cutting edge generally parallel to an axis of rotation of a respective said cutter head.

3. The wood shaving machine as set forth in claim 2 wherein the path and the cutter heads having a width adequate to accommodate a plurality of wood pieces moving side by side along the path simultaneously.

4. The wood shaving machine of claim 2 wherein the cutter head knives being positioned to remove shavings from a longitudinal face of a wood piece passing thereby.

5. The wood shaving machine of claim 4 wherein the cutter heads being positioned in the bed to remove shavings from a longitudinal face engaging the upwardly facing bed surface.

6. The wood shaving machine of claim 5 wherein the second drive device including a plurality of drive rollers with at least one said drive roller being positioned on an opposite side of the path from a respective said cutter head.

7. The wood shaving machine of claim 6 wherein the second drive device including at least two said drive rollers positioned on opposite side of the path from a respective said cutter head with one said drive roller being positioned on a feed end side of the respective cutter head and one said drive roller being positioned on a discharge end side of said respective said cutter head.

8. The wood shaving machine of claim 1 wherein the second drive device being operable to simultaneously apply generally orthogonal forces to wood pieces engaged thereby with one force being directed generally along said traverse path and one generally normal to the traverse path.

9. The wood shaving machine as set forth in claim 1 wherein the second drive device being operable to feed wood pieces to a cutter head at a speed relative to the angular velocity of a cutter on a cutter head to provide wood shavings a substantial weight proportion of which have a length of at least about one-half inch and curled in an angle of arc of at least about 30°.

10. A wood shaving machine comprising:
a first bed with a generally planer first surface and defining a first side of a wood piece movement path;
a restraining structure defining a second side of the path spaced from the first surface defining the path therebetween and operable to restrain movement of wood pieces passing therebetween except along the path;
a plurality of cutter heads positioned along the path each having at least one cutter adapted to be positioned in the path to cut wood shavings from time to time from a longitudinal face of wood moving along the path;
a first drive device operably associated with the cutter heads to effect relative movement between the cutters and wood moving along the path to effect the cutting of shavings from the wood pieces; and
a second drive device operable to effect movement of wood pieces along the path in a direction from a feed end to a discharge end of the machine, said second drive being operable to move wood pieces to be shaved sequentially to and by the cutter heads.

11. The wood shaving machine of claim 10 wherein the second drive device including a plurality of rollers each having a wood piece engaging portion positioned on the second side of the path and the cutters being positioned on the first side of the path whereby wood pieces to be shaved pass therebetween said rollers forming at least a portion of said restraining structure.

12. A wood shaving machine comprising:
a first support structure carrying a plurality of spaced apart cutter heads each having at least one cutter element; and
a second support structure carrying a plurality of spaced apart drive members, at least one drive member being associated with and spaced from a respective cutter head forming a portion of a wood piece traverse path therebetween, a wood piece moving along the traverse path being positioned between the drive members and respective cutter heads in a manner to expose an elongate side surface of a wood piece to the cutter heads for shaving wood therefrom and wherein, the drive members being operable to apply generally orthogonally directed forces to a wood piece simultaneously.

13. A method of shaving wood pieces comprising:
sequentially passing a wood piece in sequence by a plurality of cutting devices;
applying a first force to the wood piece with a drive device to induce the wood piece to move into and by a respective cutting device;
applying a second force to the wood with the drive device to hold the wood piece in cutting engagement with a respective cutting device each cutting device cutting shavings from an elongate face of the wood piece; and
transferring cut shavings away from the wood piece for collection.

14. The method as set forth in claim 13 wherein a plurality of wood pieces being fed sequentially to the cutting heads.

15. The method as set forth in claim 14 wherein the wood pieces move along a traverse path past the cutting devices generally in a single direction.

16. The method as set forth in claim 15 wherein the wood pieces include dimension lumber having generally similar cross sectional dimensions.
